(19) United States
(12) Patent Application Publication
(10) Pub. No.: US 2025/0135399 A1
(43) Pub. Date: May 1, 2025

(54) METHOD AND DEVICE FOR CONTROLLING AMMONIA ESCAPE AND SOLUBLE PARTICULATE MATTER WITH LOW ENERGY CONSUMPTION IN AN AMMONIA-BASED CARBON CAPTURE PROCESS

(71) Applicant: JIANGNAN ENVIRONMENTAL TECHNOLOGY INC, Ridgefield Park, NJ (US)

(72) Inventors: Jun Zhang, Nanjing (CN); Jing Luo, Nanjing (CN)

(21) Appl. No.: 18/631,423

(22) Filed: Apr. 10, 2024

(30) Foreign Application Priority Data
Oct. 26, 2023 (CN) 202311396166.5

(51) Int. Cl. B01D 53/75; B01D 53/14; B01D 53/22; B01D 53/50; B01D 53/58; B01D 53/62; B01D 53/73; B01D 53/78; C01C 1/242

(52) U.S. Cl. CPC B01D 53/75; B01D 53/1406; B01D 53/1475; B01D 53/1481; B01D 53/229; B01D 53/502; B01D 53/58; B01D 53/62; B01D 53/73; B01D 53/78; C01C 1/242; B01D 2251/206; B01D 2251/506; B01D 2257/302; B01D 2257/406; B01D 2257/504

(57) ABSTRACT

Methods and devices for controlling ammonia escape and soluble particulate matter formation in an ammonia-based carbon capture process are provided. After the process gas containing sulfur oxides and carbon dioxide may be treated by ammonia-based desulfurization and carbon capture, free ammonia contained in the tail gas may be removed by scrubbing the tail gas with sulfuric acid-containing solution and aqueous solution. The sulfuric acid reacts with ammonia to form ammonium sulfate, and the ammonium sulfate solution may be sent to an ammonia-based desulfurization system, where it may be crystallized together with the desulfurization byproduct ammonium sulfate to produce solid ammonium sulfate. By treating the ammonium sulfate solution in a membrane separation device, solution gradient control and system water balance may be achieved. The ammonia in the tail gas may be effectively removed, while the soluble particulate matter in the tail gas may be reduced.

### TECHNICAL FIELD

The present disclosure belongs to the technical field of environmental protection and relates to methods and devices for controlling ammonia escape and soluble particulate matter in an ammonia-based carbon capture process.

### BACKGROUND

Carbon dioxide is an important greenhouse gas, and the use of fossil energy is its main source of emissions. China ranks number one in the world in total CO₂ emissions. China's energy structure will continue to be dominated by coal for some time, and coal energy will continue to grow. Coal energy will still be the basis for new energy peak shaving and energy security. China has promised the world to reach its carbon peak by 2030 and to achieve carbon neutrality by 2060. The capture, storage, and recycling of CO₂ in flue gas is of great significance to control and reduce greenhouse gas emissions, and to deal with the greenhouse effect and global warming.

Ammonia-based carbon capture technology has been a major focus of research and is one of the best ways to manage greenhouse gases. But ammonia is volatile. Therefore, decarbonization must be carried out under alkaline conditions, resulting in an increase in ammonia escape. If this problem is not solved, a large amount of ammonia will escape, which will not only increase the cost of decarbonization, but also cause secondary pollution.

CN113262625A discloses an integrated device and method for ammonia-based desulfurization and decarbonization. The process removes sulfur oxides and CO₂ from gases through ammonia-based desulfurization and ammonia-based decarbonization. Acidic desulfurization circulating fluid is used to control ammonia escape after decarbonization, and the resulting solution is returned to the desulfurization system.

CN101909721A discloses a carbon capture system and method. The flue gas is cooled first, and ammonia-rich solution is used to absorb carbon dioxide. The flue gas after decarbonization is scrubbed with sulfuric acid to remove ammonia.

CN103857457A discloses a system and method for chilled ammonia-based carbon dioxide capture with a scrubbing system. Carbon dioxide in the flue gas is absorbed with an ammonia-rich solution, and the flue gas after decarbonization is scrubbed with water to remove ammonia. The solution obtained after ammonia-washing is further processed by nanofiltration or reverse osmosis, the dilute solution is used for ammonia removal with water, and the concentrated solution is stripped.

It would therefore be desirable to provide methods and devices for controlling ammonia escape and soluble particulate matter with low energy consumption in ammonia-based carbon capture process.

### BRIEF DESCRIPTION OF DRAWING

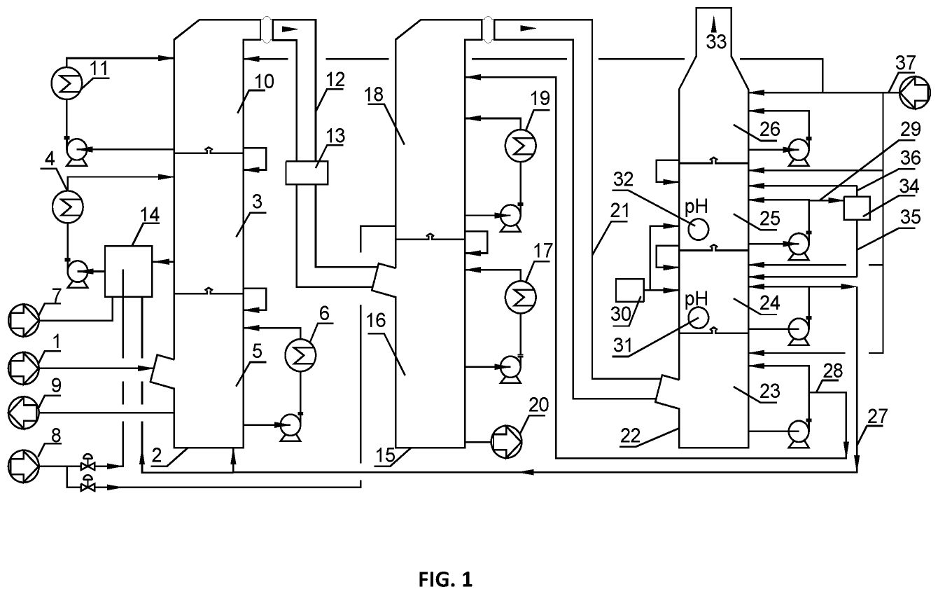

FIG. 1 shows an illustrative apparatus in accordance with the principles of the invention.
Reference numerals are as follows: 1. Process gas; 2. Ammonia-based desulfurization functional zone; 3. Absorption section; 4. Absorption section heat exchanger; 5. Cooling and concentration section; 6. Cooling and concentration section heat exchanger; 7. Oxidation air; 8. Ammonia; 9. Ammonium sulfate treatment system; 10. Scrubbing section; 11. Scrubbing section heat exchanger; 12. Tail gas after desulfurization; 13. Cooling system; 14. Desulfurization circulation tank; 15. Ammonia-based carbon capture functional zone; 16. Ammonium bicarbonate generation section; 17. Ammonium bicarbonate generation section heat exchanger; 18. CO₂ absorption section; 19. CO₂ absorption section heat exchanger; 20. Ammonium bicarbonate treatment system; 21. Tail gas after carbon capture; 22. Ammonia removal functional zone; 23. First water-washing ammonia removal section; 24. Acid-washing ammonia removal section; 25. Water-washing liquid ammonia removal section; 26. Second water-washing ammonia removal section; 27. Solution from acid-washing liquid ammonia removal section going to the desulfurization functional zone; 28. Solution from the first water-washing ammonia removal section going to the ammonia-based carbon capture functional zone; 29. Solution from the water-washing liquid ammonia removal section going to the membrane separation system; 30. Sulfuric acid-containing solution adding device; 31. Acid-washing liquid pH meter; 32. Water-washing liquid pH meter; 33. Treated flue gas; 34. Membrane separation system; 35. Membrane separation concentrated solution; 36. Membrane separation dilute solution; 37. Process water.

### DETAILED DESCRIPTION

The present disclosure provides methods and devices for controlling ammonia escape and soluble particulate matter. The methods and devices may provide for low energy consumption in an ammonia-based carbon capture process. The process gas (also known as tail gas or flue gas) containing sulfur oxides and carbon dioxide may first enter an ammonia-based desulfurization device to generate ammonium sulfate fertilizer. After desulfurization, the gas may enter an ammonia-based carbon capture device to remove the carbon dioxide in the gas, generating ammonium bicarbonate fertilizer. The gas after carbon capture may contain free ammonia. The gas may be treated with a solution containing sulfuric acid, and the sulfuric acid and ammonia may react to form ammonium sulfate. Then the remaining ammonia and ammonium sulfate droplets in the gas may be removed by scrubbing with water-washing liquid. To ensure the effectiveness of ammonia removal and reduce the ammonium sulfate entrained in the mist, the concentration (mass) of ammonium sulfate in the water-washing solution may be lower than that in the acid-washing solution. The concentration (mass) of ammonium sulfate in the water-washing solution may be not greater than 10%, not greater than 5%, not greater than 3%, or not greater than any other suitable percentage. Because the volume of the water-washing liquid may be large and water content may be high, sending the liquid directly to a stage of ammonia-scrubbing with sulfuric acid-containing solution before sending to the desulfurization system may have an impact on the water balance in the desulfurization system. The water-washing liquid may be processed in a membrane separation system, and a concentrated solution coming out from the membrane system may be sent to the stage of ammonia-scrubbing with sulfuric acid-containing solution before sending to the ammonia-based desulfurization system, where the concentrated solution together with the desulfurization by-product (ammonium sulfate) may be crystallized by using the heat from the flue gas to generate solid ammonium sulfate. The dilute solution coming out from the membrane system may return to the stage of ammonia removal with water-washing liquid scrubbing as the makeup water, achieving concentration gradient control and water balance. Through comprehensive material and energy utilization in the ammonia-based desulfurization and ammonia-based carbon capture system, it may not be necessary to add an ammonium sulfate processing unit in the ammonia removal functional zone, and controlling ammonia escape and soluble particulate matter formation with low energy consumption may be achieved. The process disclosed is simple, the capital and operating costs are low, and ammonium sulfate and ammonium bicarbonate fertilizers are produced as by-products, which truly realizes the transformation of waste into useful by-products and a recyclable economy.

Methods are provided for controlling ammonia escape and soluble particulate matter formation in an ammonia-based carbon capture process. The methods may include removing SO₂, using ammonium salt solution, from a process gas, to obtain ammonium sulfate, in an ammonia-based desulfurization vessel. A vessel may be disposed in a functional zone. A functional zone may be disposed in a vessel. The ammonium salt solution may include one or more of (NH₄)₂SO₄, NH₄HSO₄, (NH₄)₂SO₃, and NH₄HSO₃, or any other suitable salt.

The methods may include removing CO₂, using ammonium salt solution, from the process gas, in an ammonia-based carbon capture vessel. The ammonium salt solution may include one or more of (NH₄)₂CO₃, NH₄HCO₃, and NH₂COONH₄, or any other suitable salt. The methods may include removing free ammonia, using sulfuric acid solution, from the process gas, to obtain an acid-washing liquid containing ammonium sulfate, in an ammonia removal vessel. The methods may include removing both free ammonia and soluble particulate matter, using water-washing liquid, from the process gas, to obtain a water-washing liquid containing ammonium sulfate, in the ammonia removal vessel.

The methods may include sending the acid-washing liquid containing ammonium sulfate to the ammonia-based desulfurization vessel as part of ammonium salt solution. The methods may include sending the water-washing liquid containing ammonium sulfate to the ammonia removal vessel as part of sulfuric acid solution. The methods may include, before the sending, subjecting the water-washing liquid containing ammonium sulfate to membrane separation to produce a concentrated solution and a dilute solution.

The methods may include sending the concentrated solution to the ammonia removal vessel as part of the sulfuric acid solution. The methods may include sending the dilute solution to the ammonia removal vessel as part of the water-washing liquid.

The methods may include, in the removing both free ammonia and soluble particulate matter, using sulfuric acid solution, from the process gas, to obtain a water-washing liquid containing ammonium sulfate, in the ammonia removal vessel. The sulfuric acid solution used in the removing both free ammonia and soluble particulate matter may be less than the sulfuric acid solution used in the removing free ammonia.

The methods may include, before the removing free ammonia, water-washing the process gas to obtain a water-washing liquid containing ammonia. The methods may include sending the water-washing liquid containing ammonia to the ammonia-based carbon capture vessel for decarbonization.

The methods may include, after the removing both free ammonia and soluble particulate matter, water-washing the process gas to obtain a water-washing liquid containing ammonia. The methods may include using the water-washing liquid containing ammonia as water replenishment in the removing both free ammonia and soluble particulate matter.

The methods may include sending the solution containing ammonium sulfate from the ammonia removal vessel to an absorption section in the desulfurization vessel. The methods may include concentrating and crystallizing the solution containing ammonium sulfate together with the ammonium sulfate obtained in the desulfurization vessel using heat from the process gas. The methods may include producing solid ammonium sulfate in the absorption section in the desulfurization vessel.

The methods may include sending the solution containing ammonium sulfate from the ammonia removal vessel to a cooling and concentration section in the desulfurization vessel. The methods may include concentrating and crystallizing the solution containing ammonium sulfate together with the ammonium sulfate obtained in the desulfurization vessel using heat from the process gas. The methods may include producing solid ammonium sulfate in the cooling and concentration section in the desulfurization vessel.

The methods may include, before the removing free ammonia, producing solid ammonium bicarbonate in the carbon capture vessel. The methods may include, in the removing free ammonia, adding a sulfuric acid-containing solution to a gas-liquid contacting solution. The sulfuric acid-containing solution may be added before the gas-liquid contacting solution is sprayed from a gas-liquid contacting device. The gas-liquid contacting device may be included in a layer. The layer may include one or more gas-liquid contacting devices. The methods may include obtaining a pH of the gas-liquid contacting solution in the range of 1-6.5 by adding the sulfuric acid-containing solution. The methods may include obtaining a pH of the gas-liquid contacting solution in the range of 2-5.5 by adding the sulfuric acid-containing solution. The methods may include obtaining a pH of the gas-liquid contacting solution in any other suitable range.

The acid-washing liquid may have an ammonium sulfate mass concentration that may be not less than 15%. The acid-washing liquid may have an ammonium sulfate mass concentration that may be not less than 20%. The acid-washing liquid may have an ammonium sulfate mass concentration that may be not less than 25%. The acid-washing liquid may have an ammonium sulfate mass concentration of any other suitable percentage.

Methods are provided for controlling ammonia escape and soluble particulate matter formation. The methods may be associated with low energy consumption. The methods may include an ammonia-based carbon capture process. The methods may include:
1) removing part of the SO₂ in the process gas with ammonium salt solution;
2) removing part of the CO₂ in the treated process gas after 1) with ammonium salt solution;
3) removing part of the free ammonia in the treated process gas after 2) with a solution containing sulfuric acid to obtain an acid-washing solution containing ammonium sulfate, and at least part of the acid-washing solution containing ammonium sulfate generated may be sent to 1);
4) removing part of the free ammonia and soluble particulate matter in the treated process gas after 3) with water washing liquid to obtain a water-washing liquid containing ammonium sulfate, and at least part of the water-washing liquid containing ammonium sulfate generated may be sent to 3).

Gas pollutants mainly include nitrogen oxides, sulfur oxides, and particulate matter. Soluble particulate matter refers to particulate matter that is soluble in water. In the ammonia-based carbon capture process, soluble particulate matter mainly includes ammonium sulfate and ammonium bicarbonate. Since ammonium bicarbonate may be generated in 2), mist droplets containing ammonium bicarbonate may be entrained in the gas phase. Ammonium sulfate may be generated in 1) and 3), and mist droplets containing ammonium sulfate may be entrained in the gas phase. When mist droplets containing ammonium bicarbonate and ammonium sulfate enter the atmosphere, solid particles may form as the water evaporates. A testing method for particulate matter may include HJ 836 (“Determination of low-concentration particulate matter in exhaust gas of stationary pollution source-Gravimetric method”).

The content of soluble particulate matter in the treated flue gas obtained by the methods and devices for controlling ammonia escape and soluble particulate matter with low energy consumption through ammonia-based carbon capture of the present disclosure may be 0-2 mg/Nm³, 0-1.8 mg/Nm³, 0-1.5 mg/Nm³, 0-1.2 mg/Nm³, or any other suitable range. In addition, after being processed by the methods and devices for controlling ammonia escape and soluble particulate matter by ammonia-based carbon capture with low energy consumption according to the present disclosure, the soluble particulate matter may be reduced by at least 50%, at least 60%, at least 70%, at least 75%, or at least any other suitable percentage.

In some embodiments, at least part of the water-washing liquid in 4) may be subjected to membrane separation, the concentrated solution generated may be sent to 3), and the dilute solution generated may be returned to 4).

In some embodiments, the sulfuric acid-containing solution may be added in 4), and the added amount of the sulfuric acid-containing solution may be not higher than that in 3). The ratio of the amount of sulfuric acid solution added in 4) to 3) may be not higher than 50%, not higher than 30%, not higher than 15%, or not higher than any other suitable percentage.

In some embodiments, before 3), ammonia removal with water-washing may also be included, and the aqueous ammonia solution obtained may be sent to 2) for decarbonization.

In some embodiments, after 4), ammonia removal with water-washing may also be included, and the aqueous ammonia solution obtained may be used as makeup water in 4).

In some embodiments, the desulfurization functional zone in 1) may include an absorption section, and the ammonium sulfate-containing solution generated in 3) may be sent to the absorption section. The solution may be concentrated and crystallized by using the heat in the flue gas together with the desulfurization by-product ammonium sulfate, to produce solid ammonium sulfate.

In some embodiments, the desulfurization functional zone of 1) may include a cooling and concentration section. The ammonium sulfate-containing solution produced in 3) may be sent to the cooling and concentration section. The solution may be concentrated and crystallized by using the heat from the flue gas together with the desulfurization by-product ammonium sulfate, to produce solid ammonium sulfate.

To utilize the heat from the flue gas to concentrate and crystallize the ammonium sulfate solution, the temperature of the flue gas before desulfurization may be 105° C. or higher, at which temperatures the flue gas may be unsaturated.

In some embodiments, solid ammonium bicarbonate may be produced in 2).

In some embodiments, a gas-liquid contacting device may be provided in 3), producing at least one layer of a gas-liquid contacting solution, and a pH of the gas-liquid contacting solution may be controlled to be in the range of 1-6.5 by adding solution containing sulfuric acid. The pH of the gas-liquid contacting solution may be controlled to be in the range of 2-5.5 by adding solution containing sulfuric acid. The pH of the gas-liquid contacting solution may be controlled to be in any other suitable range.

In some embodiments, the concentration (mass) of the solution containing ammonium sulfate in 3) may be controlled to be not less than 15%, not less 20%, not less than 25%, or not less than any other suitable percentage.

In some embodiments, in 3), the concentration of the ammonium sulfate solution may be adjusted by makeup water in 3), and the makeup water may come from the water-washing liquid in 4) or process water.

In some embodiments, the concentration (mass) of the water-washing liquid containing ammonium sulfate in 4) may be less than that of the acid-washing solution containing ammonium sulfate in 3), not greater than 10%, not greater than 5%, not greater than 3%, or not greater than any other suitable percentage.

In some embodiments, in 4), the concentration of the ammonium sulfate solution may be adjusted by makeup water, and the makeup water may come from process water.

In some embodiments, the concentration (mass) of ammonium sulfate in the concentrated solution may be not less than 15%, not less than 20%, not less than 25%, or not less than any other suitable percentage.

In some embodiments, the concentration (mass) of ammonium sulfate in the dilute solution may be not greater than 5%, not greater than 3%, not greater than 1%, or not greater than any other suitable percentage.

In some embodiments, 1) may include an ammonia-based desulfurization functional zone, which may include a cooling and concentration section, an absorption section, and a washing section. In the cooling and concentrating section, the pH of the circulating liquid may be in the range of 1-6, in the range of 2-4.5, or in any other suitable range, the concentration of ammonium sulfite may be 0-0.2 wt % or any other suitable wt %, and the concentration of ammonium sulfate may be 10-60 wt % or any other suitable wt %. In the absorption section, the pH of the circulating liquid may be in the range of 4.5-6.5, in the range of 4.8-6.2, or in any other suitable range, the concentration of ammonium sulfite may be 0.1-3 wt % or any other suitable wt %, and the concentration of ammonium sulfate may be 10-38 wt % or any other suitable wt %. In the washing section, the pH of the circulating fluid may be in the range of 1.5-6.5, in the range of 2-5, or in any other suitable range, and the concentration of ammonium sulfate may be 0-5 wt % or any other suitable wt %.

In some embodiments, 2) may include an ammonia-based carbon capture functional zone, which may include an ammonium bicarbonate generation section and a decarbonization absorption section. The molar ratio of total ammonia to total CO₂ in the circulating liquid of the ammonium bicarbonate generation section may be in the range of 1-1.8. The molar ratio of total ammonia to total CO₂ in the circulating liquid of the decarbonization absorption section may be in the range of 1.8-3. The total ammonia may include ammonia and ammonium ion, and the total CO₂ may include free CO₂ and carbonated CO₂.

In some embodiments, the sulfuric acid-containing solution used in 3) may include sulfuric acid, aqueous solutions containing sulfuric acid at various concentrations, or aqueous solutions containing sulfuric acid and ammonium sulfate.

Devices for controlling ammonia escape and soluble particulate matter are provided. The devices may use low energy consumption in an ammonia-based carbon capture process. The devices, along the flue gas flow direction, may include an ammonia-based desulfurization functional zone, an ammonia-based carbon capture functional zone, and an ammonia removal functional zone.

The ammonia removal functional zone may include the first ammonia removal system, the second ammonia removal system, and the sulfuric acid-containing solution addition system.

The sulfuric acid-containing solution addition system may be connected to the first ammonia removal system and the second ammonia removal system through a liquid-phase pipeline. The second ammonia removal system may be located after the first ammonia removal system, along the direction of flue gas flow. The second ammonia removal system may be connected to the first ammonia removal system through a liquid-phase pipeline. And the first ammonia removal system may be connected to the ammonia-based desulfurization functional zone through a liquid-phase pipeline.

In some embodiments, a membrane separation system may be provided on the pipeline connecting the first ammonia removal system and the second ammonia removal system.

In some embodiments, a water-washing ammonia removal system may be further included before the first ammonia removal system.

In some embodiments, a second water-washing ammonia removal system may be further included before the second ammonia removal system.

In some embodiments, the ammonia-based desulfurization functional zone may include an absorption section, and the membrane separation system may be connected to the absorption section through a liquid-phase pipeline.

In some embodiments, the ammonia-based desulfurization functional zone may include a cooling and concentration section, and the membrane separation system may be connected to the cooling and concentration section through a liquid phase pipeline.

In some embodiments, the ammonia-based desulfurization functional zone may include a solid ammonium sulfate treatment unit, and the ammonia-based decarbonization functional zone may include a solid ammonium bicarbonate treatment unit.

In some embodiments, the first ammonia removal system may include a pH measuring device, an ammonium sulfate concentration measuring device, and at least one layer of a gas-liquid contacting device.

In some embodiments, the first ammonia removal system and the second ammonia removal system may be provided with a water replenishment port.

In some embodiments, the first ammonia removal system may be provided with an acid-washing liquid ammonia removal section.

In some embodiments, the second ammonia removal system may be provided with a water-washing liquid ammonia removal section.

In some embodiments, the ammonia-based desulfurization functional zone may be divided into multiple sections, including a cooling and concentration section, an absorption section, and a water washing section. Each section may be provided with at least one layer of gas-liquid contact, and equipment/components may be provided between sections allowing gas to pass through the sections.

In some embodiments, the ammonia-based desulfurization functional zone may be divided into multiple sections, including an ammonium bicarbonate generation section and a decarbonization absorption section. Each section may be provided with at least one layer of gas-liquid contact, and equipment/components may be provided between sections allowing gas to pass through the sections.

The methods disclosed may be carried out in devices for controlling ammonia escape and soluble particulate matter with low energy consumption in the ammonia-based carbon capture process in the present disclosure.

The methods and devices may involve some or all of the following embodiments:

1. A method for controlling ammonia escape and soluble particulate matter. The method may use low energy consumption in an ammonia-based carbon capture process. The method may include:
1) Removing part of the SO₂ in the process gas with ammonium salt solution;
2) Removing part of the CO₂ in the process gas treated in 1) with ammonium salt solution;
3) Removing part of the free ammonia in the process gas treated in 2) with sulfuric acid-containing solution, obtaining an ammonium sulfate-containing acid-washing liquid. At least part of the ammonium sulfate-containing acid-washing liquid generated may be sent to 1);
4) Removing part of the free ammonia and soluble particulate matter in the process gas treated in 3) with water-washing liquid and obtaining an ammonium sulfate-containing water-washing liquid. At least part of the ammonium sulfate-containing water-washing liquid generated may be sent to 3).

2. The method according to embodiment 1, characterized in that at least part of the water-washing liquid in 4) may be subjected to membrane separation, from which the concentrated solution generated may be sent to 3) and the dilute solution generated may be returned to 4).

3. The method according to embodiment 1, characterized in that, in 4), a sulfuric acid-containing solution may be added, and the amount of the sulfuric acid-containing solution added may not be more than the amount added in 3).

4. The method according to embodiment 1, characterized in that before 3), a water-washing ammonia removal may be included, and the aqueous ammonia solution obtained may be sent to 2) for decarbonization.

5. The method according to embodiment 1, characterized in that, after 4), a water-washing ammonia removal may be included, and the aqueous ammonia solution obtained may be used as makeup water in 4).

6. The method according to embodiment 1, characterized in that, in the desulfurization functional zone of 1), an absorption section may be included. The ammonium sulfate-containing solution generated in 3) may be sent to the absorption section and concentrated and crystallized together with the desulfurization by-product ammonium sulfate by using the heat from the flue gas to produce solid ammonium sulfate.

7. The method according to embodiment 1, characterized in that, in the desulfurization functional zone of 1), a cooling and concentration section may be included. The ammonium sulfate-containing solution generated in 3) may be sent to the cooling and concentration section and may be concentrated and crystallized together with the desulfurization by-product ammonium sulfate by using the heat from the flue gas to produce solid ammonium sulfate.

8. The method according to embodiment 1, characterized in that solid ammonium bicarbonate may be produced in 2).

9. The method according to embodiment 1, characterized in that at least one layer of gas-liquid contacting device may be provided in 3), and the pH of the gas-liquid contacting solution may be controlled to be in the range of 1-6.5 by adding a sulfuric acid-containing solution. The pH of the gas-liquid contacting solution may be controlled to be in the range of 2-5.5 by adding a sulfuric acid-containing solution. The pH of the gas-liquid contacting solution may be controlled to be in any other suitable range.

10. The method according to embodiment 1, characterized in that the concentration (mass) of the ammonium sulfate-containing acid-washing liquid in 3) may be controlled to be not less than 15%, not less than 20%, not less than 25%, or not less than any other suitable percentage.

11. The method according to embodiment 1, characterized in that in 3), the concentration of the ammonium sulfate solution may be adjusted by makeup water, which may come from water-washing liquid in 4) or process water.

12. The method according to embodiment 1, characterized in that the concentration (mass) of the ammonium sulfate-containing water-washing solution in 4) may be controlled to be less than the concentration (mass) of the ammonium sulfate-containing acid-washing solution in 3). The concentration (mass) of the ammonium sulfate-containing acid-washing solution in 3) may be not more than 10%, not more than 5%, not more than 3%, or not more than any other suitable percentage.

13. The method according to embodiment 1, characterized in that, in 4), the concentration of the ammonium sulfate solution may be adjusted by adding water, which may come from process water.

14. The method according to embodiment 2, characterized in that the concentration (mass) of ammonium sulfate in the concentrated solution may be not less than 15%, not less than 20%, not less than 25%, or not less than any other suitable percentage.

15. The method according to embodiment 2, characterized in that the concentration (mass) of ammonium sulfate in dilute solution may be not more than 5%, not more than 3%, not more than 1%, or not more than any other suitable percentage.

16. The method according to embodiment 1, characterized in that an ammonia-based desulfurization functional zone may be included in 1). The ammonia-based desulfurization functional zone may include a cooling and concentration section, an absorption section, and a washing section. The pH of the circulating liquid in the cooling and concentration section may be in the range of 1-6, in the range of 2-4.5, or in any other suitable range. The ammonium sulfite concentration in the cooling and concentration section may be 0-0.2 wt % or any other suitable wt %. The ammonium sulfate concentration in the cooling and concentration section may be 10-60 wt % or any other suitable wt %. The absorption section circulating fluid pH may be in the range of 4.5-6.5, in the range of 4.8-6.2, or in any other suitable range. The ammonium sulfite concentration in the absorption section may be 0.1-3 wt % or any other suitable wt %. The ammonium sulfate concentration in the absorption section may be 10-38 wt % or any other suitable wt %. The washing section circulating liquid pH may be in the range of 1.5-6.5, in the range of 2-5, or in any other suitable range. The ammonium sulfate concentration in the washing section may be 0-5 wt % or any other suitable wt %.

17. The method according to embodiment 1, characterized in that 2) may include an ammonia-based carbon capture functional zone. The ammonia-based carbon capture functional zone may include an ammonium bicarbonate generation section and a decarbonization absorption section. The molar ratio of total ammonia to total CO₂ in the ammonium bicarbonate generation section circulating fluid of the ammonium generation section may be 1-1.8. The molar ratio of total ammonia to total CO₂ in the circulating fluid of the decarbonization absorption section may be 1.8-3. The total ammonia may include ammonia and ammonium radicals, and the total CO₂ may include free CO₂ and carbonized CO₂.

18. The method according to embodiment 1, characterized in that the sulfuric acid-containing solution used in 3) may include sulfuric acid, aqueous solutions containing sulfuric acid at various concentrations, or aqueous solutions containing sulfuric acid and ammonium sulfate.

19. A device for controlling ammonia escape and soluble particulate. The device may use low energy consumption in an ammonia-based carbon capture process. The device may include, along the direction of flue gas flow, an ammonia-based desulfurization functional zone, an ammonia-based carbon capture functional zone, and an ammonia removal functional zone.

The ammonia removal functional zone may include: the first ammonia removal system, the second ammonia removal system, and the sulfuric acid-containing solution addition system.

The sulfuric acid-containing solution addition system may be connected to the first ammonia removal system and the second ammonia removal system through a liquid-phase pipeline. The second ammonia removal system may be located after the first ammonia removal system, along the direction of flue gas flow. The second ammonia removal system may be connected to the first ammonia removal system through a liquid-phase pipeline. The first ammonia removal system may be connected to the ammonia-based desulfurization functional zone through a liquid phase pipeline.

20. The device according to embodiment 19, characterized in that a membrane separation system may be provided on the pipeline connecting the first ammonia removal system and the second ammonia removal system.

21. The device according to embodiment 19, characterized in that, before the first ammonia removal system, a first water-washing ammonia removal system may be further included, and the first water-washing ammonia removal system may be provided with at least one layer of gas-liquid contacting device.

22. The device according to embodiment 19, characterized in that, before the second ammonia removal system, a second water-washing ammonia removal system may be further included, and the second water-washing ammonia removal system may be provided with at least one layer of gas-liquid contacting device.

23. The device according to embodiment 19, characterized in that the ammonia-based desulfurization functional zone may include an absorption section, and the membrane separation system may be connected to the absorption section through a liquid phase pipeline.

24. The device according to embodiment 19, characterized in that the ammonia-based desulfurization functional zone may include a cooling and concentration section, and the membrane separation system may be connected to the cooling and concentration section through a liquid phase pipeline.

25. The device according to embodiment 19, wherein the ammonia-based desulfurization functional zone may include a solid ammonium sulfate treatment unit, and the ammonia-based carbon capture functional zone may include a solid ammonium bicarbonate treatment unit.

26. The device according to embodiment 19, characterized in that the first ammonia removal system may include a pH measuring device, an ammonium sulfate concentration measuring device, and at least one layer of gas-liquid contacting device.

27. The device according to embodiment 19, characterized in that the first ammonia removal system and the second ammonia removal system may be provided with water replenishment ports.

28. The device according to embodiment 19, characterized in that the first ammonia removal system may be provided with an acid-washing liquid ammonia removal section.

29. The device according to embodiment 19, characterized in that the second ammonia removal system may be provided with a water-washing liquid ammonia removal section.

The methods and devices may have one or more of the following features:

1. Through acid-washing and multi-stage gradient washing, ammonia escape after ammonia-based carbon capture may be efficiently controlled below 3 ppmV.

2. The effectiveness of ammonia removal may be improved by controlling the ammonium sulfate concentration and pH value in the washing solution.

3. By controlling the ammonium sulfate concentration in the water-washing liquid, the effectiveness of ammonia removal may be improved, and the ammonium sulfate entrained in the gas phase may be washed out.

4. Ammonium sulfate-containing water-washing liquid may be treated in membrane separation equipment with low energy consumption, maintaining water balance in the system.

5. The ammonium sulfate solution in the ammonia removal functional zone may be sent to the ammonia-based desulfurization functional zone and may be crystallized together with the desulfurization byproduct ammonium sulfate by using the heat from the flue gas to produce solid ammonium sulfate, without additional processing equipment, reducing energy consumption in the operation.

6. The dilute solution coming from membrane separation may be returned to water-washing liquid as replenishing water to realize the purification of the water-washing liquid. The concentrated solution may be reused in acid-washing liquid ammonia removal section.

7. Organically combining ammonia-based desulfurization with ammonia-based carbon capture may realize overall ammonia addition control, water replenishment control, ammonia escape control, and energy consumption control.

8. A combination of scrubbing with a sulfuric acid-containing solution, staged solution control, and membrane separation with low energy consumption for ammonia escape control. Further, the solutions obtained in membrane separation may be effectively processed and utilized in the disclosed devices and methods.

The steps of illustrative methods may be performed in an order other than the order shown or described herein. Some embodiments may omit steps shown or described in connection with the illustrative methods. Some embodiments may include steps that are neither shown nor described in connection with the illustrative methods. Illustrative method steps may be combined. For example, one illustrative method may include steps shown in connection with another illustrative method.

Some embodiments may omit features shown or described in connection with the illustrative devices. Some embodiments may include features that are neither shown nor described in connection with the illustrative devices. Features of illustrative devices may be combined. For example, one illustrative embodiment may include features shown in connection with another illustrative embodiment.

Embodiments may involve some or all of the features of the illustrative devices or some or all of the steps of the illustrative methods.

The illustrative apparatus, devices, and methods will now be described with reference to the accompanying Figure, which forms a part hereof. It is to be understood that other embodiments may be utilized, and that structural, functional, and procedural modifications may be made without departing from the scope and spirit of the present disclosure.

### Example 1

In FIG. 1, the process gas 1 (also known as tail gas or flue gas) containing sulfur oxides and CO₂ entered the ammonia-based desulfurization functional zone 2, which included a cooling and concentration section 5, an absorption section 3, and a scrubbing section 10. Each section was provided with at least one layer of gas-liquid contact. The solution in each section was forced to circulate through the circulation pump. Devices/components that allowed gas to pass through were provided between sections. In the ammonia-based desulfurization functional zone 2, process gas 1 was treated through spraying and circulation with the circulation pump in the cooling and concentration section 5. The temperature was controlled by the heat exchanger 6 in the cooling and concentration section. The ammonium sulfate solution was concentrated while the tail gas was cooled. The ammonium sulfate slurry containing solid ammonium sulfate was processed in the ammonium sulfate treatment system 9 to obtain ammonium sulfate product. The sulfur oxides (sulfur dioxide and sulfur trioxide) in the flue gas were then absorbed through spraying and circulation with the circulation pump in the desulfurization absorption section 3 and the desulfurization circulation tank 14. The absorption temperature was controlled by the heat exchanger 4 in the absorption section. Scrubbing and spraying circulation were carried out by circulation pump in the desulfurization scrubbing section 10. The scrubbing temperature was controlled by the heat exchanger 11 in the desulfurization water-washing section. The process water 37 was replenished to the desulfurization scrubbing section 10, the solution from the desulfurization scrubbing section 10 enters the desulfurization absorption section 3 through pipelines as makeup water, and the solution from the desulfurization absorption section 3 entered the desulfurization cooling and concentration section 5 through pipeline as makeup water.

Ammonia 8 was added to the desulfurization circulation tank 14 after metering. The oxidation air 7 was introduced into the desulfurization circulation tank 14 to oxidize the solution.

After desulfurization, tail gas 12 was cooled down in cooling system 13 before entering the ammonia-based carbon capture functional zone 15. The ammonia-based carbon capture functional zone 15 included an ammonium bicarbonate generation section 16 and a carbon dioxide absorption section 18. Each section was provided with at least one layer of gas-liquid contact. The solution in each section was forced to circulate through the circulation pump. Devices/components were provided between sections to allow gas to pass through. In the ammonia-based carbon capture functional zone 15, the cooled tail gas was treated through spraying and circulation with the circulation pump in the ammonium bicarbonate generation section 16. The heat of reaction and heat of crystallization were removed by ammonium bicarbonate generation section heat exchanger 17. Ammonium bicarbonate product was obtained in the ammonium bicarbonate treatment system 20. The tail gas was treated through spray circulation with the circulation pump in the carbon dioxide absorption section 18, and the heat of reaction was removed by the carbon dioxide absorption section heat exchanger 19. The replenishing water of the ammonia carbon capture functional zone 15 was replenished through process water 37 from the carbon dioxide absorption section 18 or through the circulation pump pipeline of the first water-washing ammonia removal section 23. The solution from the carbon dioxide absorption section 18 entered the ammonium bicarbonate generation section 16 through pipelines as makeup water. Ammonia 8 was metered and added to the carbon dioxide absorption section 18.

The treated gas after carbon capture (i.e., the tail gas after carbon capture) 21 entered the ammonia removal functional zone 22. The ammonia removal functional zone 22 included, along the direction of gas flow, the first water-washing ammonia removal section 23, acid-washing liquid ammonia removal section 24, water-washing liquid ammonia removal section 25, and the second water-washing ammonia removal section 26. At least one layer of gas-liquid contact was provided in each section. The solution in each section was forced to circulate through the circulation pump. Devices/components provided allowed gas to pass through and between sections. In the ammonia removal functional zone 22, the ammonia in tail gas 21 was absorbed through spraying and circulation with the circulation pump in the first water-washing ammonia removal section 23. The obtained ammonia-containing solution 28 was sent to the carbon dioxide absorption section 18. There, ammonia-containing solution 28 was used as water replenishment for the ammonia-based carbon capture functional zone 15. Further, the ammonia in the ammonia-containing solution 28 was used as an absorbent to capture carbon dioxide in the tail gas 21. Spraying and circulation was carried out by the circulation pump of the acid-washing liquid ammonia removal section 24 to absorb the ammonia in the tail gas 21. The ammonium sulfate-containing solution obtained 27 was sent to the cooling and concentration section 5 and/or the absorption section 3. There, ammonium sulfate-containing solution 27 was used as water replenishment for the ammonia-based desulfurization functional zone 2. Further, the heat from process gas 1 was used for concentrating and crystallizing the ammonium sulfate-containing solution 27 together with the desulfurization by-product ammonium sulfate to form solid ammonium sulfate. And an ammonium sulfate product was obtained through ammonium sulfate treatment system 9, which reduced energy consumption without additional processing equipment. Spraying and circulation was performed through the circulation pump in the water-washing liquid ammonia removal section 25 to absorb the ammonia in the gas. And the obtained ammonium sulfate-containing solution 29 was sent to the acid-washing liquid ammonia removal section 24. Spraying and circulation were performed through the circulation pump in the second water-washing ammonia removal section 26 to remove the ammonia in the tail gas 21. And the solution obtained was sent to water-washing liquid ammonia removal section 25 as replenishing water. The treated flue gas 33 after ammonia removal was discharged. The ammonia removal functional zone 22 was provided with a sulfuric acid solution adding device 30, an acid-washing liquid pH meter 31, and a water-washing liquid pH meter 32. The sulfuric acid-containing solution adding device 30 was used to add sulfuric acid to acid-washing liquid ammonia removal section 24 and/or water-washing liquid ammonia removal section 25, and to adjust the pH value of the solution.

The ammonia removal functional zone 22 also included a membrane separation system 34. The membrane separation system 34 received the ammonium sulfate solution generated in the water-washing liquid ammonia removal section. The concentrated solution 35 obtained in membrane separation was sent to the acid-washing liquid ammonia removal section 24. The dilute solution 36 obtained in membrane separation was returned to the water-washing liquid ammonia removal section 25, to purify the solution in water-washing liquid ammonia removal section. The zones into which the process water 37 entered as replenishing water included: the scrubbing section 10 of the ammonia-based desulfurization functional zone 2, the carbon dioxide absorption section 18 of the ammonia-based carbon capture functional zone 15, the first water-washing ammonia removal section 23 of the ammonia removal functional zone 22, acid-washing liquid ammonia removal section 24, water-washing liquid ammonia removal section 25, and the second water-washing ammonia removal section 26.

The pH value of the pH meter 31 was controlled to be in the range 2-5.5. The pH value of the pH meter 32 was controlled to be in the range of 1-7.

The ratio of the amount of sulfuric acid added through the sulfuric acid solution adding device 30 to the acid-washing liquid ammonia removal section 24 to the amount of sulfuric acid added to the water-washing liquid ammonia removal section 25 was 5%-15%. The ammonium sulfate concentration (mass) in the circulating liquid in the acid-washing liquid ammonia removal section 24 was 20-30%. The ammonium sulfate concentration (mass) in the circulating liquid in the water-washing liquid ammonia removal section was 0.5-3%. The concentrated solution 35 separated from the membrane separation system 34, with an ammonium sulfate concentration (mass) of 20-30%, was sent to the acid-washing liquid ammonia removal section 24. The dilute solution 36, with an ammonium sulfate concentration (mass) of 0.1-1%, was sent to the water-washing liquid ammonia removal section 25. The amount of ammonium sulfate in the circulating liquid in the second water-washing ammonia removal section 26 was low, with a concentration (mass) of 0-0.5%.

Ammonia 8 was anhydrous ammonia with 99.6% concentration by weight.

The parameters of process gas 1, the treated gas (i.e., the tail gas after carbon capture) 21 after the treatment in desulfurization functional zone 2 and carbon capture functional zone 15, and treated gas 33 (i.e., the clean flue gas) after the treatment in ammonia removal functional zone 22 are given in the table below:

| | | Process | Treated | Treated |
|---|---|---|---|---|
| No. | Item | gas 1 | gas 21 | gas 33 |
| 1 | Flowrate, Nm³/h | 93058 | 83922 | 89904 |
| 2 | Temperature, ° C. | 132 | 20 | 42 |
| 3 | SO₂ content, mg/Nm³ | 2200 | 3 | <3 |
| 4 | CO₂ content, v % | 12.9 | 4.3 | 4.0 |
| 5 | NH₃ content, ppmv | 0 | 1000 | <3 |
| 6 | Soluble particulate matter, mg/Nm³ | 4.5 | 4 | 1 |

Through acid-washing and water-washing in the ammonia removal functional zone, soluble particles such as ammonium sulfate and ammonium bicarbonate entrained in the mist droplets in the process gas were significantly reduced.

### Comparative Example 1

Compared with Example 1, the water-washing liquid ammonia removal section 25 and the membrane separation system 34 were not provided. The solution in the second water-washing ammonia removal section 26 entered the acid-washing liquid ammonia removal section 24 as makeup water. Other processes remained unchanged. During operation, the mist droplets containing ammonium sulfate in the acid-washing liquid ammonia removal section 24 entered the second water-washing ammonia removal section 26, causing the concentration of the solution in the second water-washing ammonia removal section 26 to increase, and controlling ammonia escape and soluble particulate matter through water-washing was not achieved. A large amount of makeup water was added by using process water 37 to dilute the solution in the second water-washing ammonia removal section 26, the amount of water was too large, and the water balance of the system was not maintained.

### Comparative Example 2

Compared with Example 1, the membrane separation system 34 was not provided and the solution in the water-washing liquid ammonia removal section 25 was sent to the acid-washing liquid ammonia removal section 24. Other processes remained unchanged. The ammonium sulfate concentration (mass) of the circulating liquid in the water-washing liquid ammonia removal section 24 was kept at 0.5-3%. As in Example 1, the amount of water was too large, which diluted the solution of the acid-washing ammonia removal section 24. A large amount of water continued entering the ammonia-based desulfurization functional zone 2 through pipeline 27. The water was not completely processed in the ammonia-based desulfurization functional zone 2. The water was only processed by adding new evaporation and crystallization equipment, which further increased investment and operating costs.

As will be appreciated by one of skill in the art, devices and methods shown or described herein may be embodied in whole or in part as a method, an apparatus or product by process. Accordingly, such devices may take the form of, and such methods may be performed by, an entirely hardware embodiment, an entirely software embodiment or an embodiment combining software, hardware and any other suitable approach or apparatus.

All ranges and parameters disclosed herein shall be understood to encompass any and all subranges subsumed therein, every number between the endpoints, and the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 10.4, 3 to 8, 4 to 7), and finally to each number 1, 2, 3, 4, 5, 6, 7, 8, 10, and 10 contained within the range.

Thus, methods and devices for controlling ammonia escape and soluble particulate matter in an ammonia-based carbon capture process have been provided. Persons skilled in the art will appreciate that the disclosure may be practiced by other than the described embodiments, which are presented for purposes of illustration rather than of limitation. The disclosure is limited only by the claims that follow.

What is claimed is:

1. A method of controlling ammonia escape and soluble particulate matter formation in an ammonia-based carbon capture process, the method comprising:
removing SO₂, using ammonium salt solution, from a process gas, to obtain ammonium sulfate, in an ammonia-based desulfurization vessel;
removing CO₂, using ammonium salt solution, from the process gas, in an ammonia-based carbon capture vessel;
removing free ammonia, using sulfuric acid solution, from the process gas, to obtain an acid-washing liquid containing ammonium sulfate, in an ammonia removal vessel;
removing both free ammonia and soluble particulate matter, using water-washing liquid, from the process gas, to obtain a water-washing liquid containing ammonium sulfate, in the ammonia removal vessel;
sending:
the acid-washing liquid containing ammonium sulfate to the ammonia-based desulfurization vessel as part of ammonium salt solution; and
the water-washing liquid containing ammonium sulfate to the ammonia removal vessel as part of sulfuric acid solution.

2. The method of claim 1 further comprising:
before the sending:
subjecting the water-washing liquid containing ammonium sulfate to membrane separation to produce a concentrated solution and a dilute solution; and
sending:
the concentrated solution to the ammonia removal vessel as part of the sulfuric acid solution; and
the dilute solution to the ammonia removal vessel as part of the water-washing liquid.

3. The method of claim 1 further comprising, in the removing both free ammonia and soluble particulate matter, using sulfuric acid solution, from the process gas, to obtain a water-washing liquid containing ammonium sulfate, in the ammonia removal vessel; wherein the sulfuric acid solution used in the removing both free ammonia and soluble particulate matter is less than the sulfuric acid solution used in the removing free ammonia.

4. The method of claim 1 further comprising, before the removing free ammonia, water-washing the process gas to obtain a water-washing liquid containing ammonia; and
sending the water-washing liquid containing ammonia to the ammonia-based carbon capture vessel for decarbonization.

5. The method of claim 1 further comprising:
after the removing both free ammonia and soluble particulate matter, water-washing the process gas to obtain a water-washing liquid containing ammonia; and
using the water-washing liquid containing ammonia as water replenishment in the removing both free ammonia and soluble particulate matter.

6. The method of claim 1 further comprising:
sending the solution containing ammonium sulfate from the ammonia removal vessel to an absorption section in the desulfurization vessel;
concentrating and crystallizing the solution containing ammonium sulfate together with the ammonium sulfate obtained in the desulfurization vessel using heat from the process gas; and
producing solid ammonium sulfate.

7. The method of claim 1 further comprising:
sending the solution containing ammonium sulfate from the ammonia removal vessel to a cooling and concentration section in the desulfurization vessel;
concentrating and crystallizing the solution containing ammonium sulfate together with the ammonium sulfate obtained in the desulfurization vessel using heat from the process gas; and
producing solid ammonium sulfate.

8. The method of claim 1 further comprising, before the removing free ammonia, producing solid ammonium bicarbonate in the carbon capture vessel.

9. The method of claim 1 further comprising, in the removing free ammonia, obtaining a pH of a gas-liquid contacting solution in the range of 1-6.5 by adding a sulfuric acid-containing solution to the gas-liquid contacting solution before the gas-liquid contacting solution is sprayed from a gas-liquid contacting device included in a gas-liquid contacting device layer.

10. The method of claim 9 wherein the range is 2-5.5.

11. The method of claim 1 wherein the acid-washing liquid has an ammonium sulfate mass concentration that is not less than 15%.

12. The method of claim 1 wherein the acid-washing liquid has an ammonium sulfate mass concentration that is not less than 20%.

13. The method of claim 1 wherein the acid-washing liquid has an ammonium sulfate mass concentration that is not less than 25%.
